(19) United States
(12) Patent Application Publication
(10) Pub. No.: US 2008/0095069 A1
(43) Pub. Date: Apr. 24, 2008

(54) Apparatus And Method For Determining Call Quality In A Communication System

(75) Inventors: Howard J. Thomas, Cirencester (GB); Trevor T. Hanna, Dowdewell (GB)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/908,559

(22) PCT Filed: May 1, 2006
(86) PCT No.: PCT/US06/16574

§ 371 Date: Sep. 13, 2007

(30) Foreign Application Priority Data
Jun. 29, 2005 (GB) 0513145.3

(51) Int. Cl. H04J 1/02

(52) U.S. Cl. 370/252

(57) ABSTRACT

A communication system comprises functionality for measuring call quality in connection with a user termination of a call. Specifically, a call quality estimator (119) comprises a termination processor (201) which determines a user call termination for a call. In response to the detection, a quality estimator (203) determines a termination call quality measure for a call quality at the user call termination. For example, an error rate in a time interval of duration between 10 seconds and 60 seconds before the detection of the call termination may be determined. A transmit controller (205) then transmits the termination call quality measure to a call quality processor (117). The call quality processor (117) may statistically process the termination call quality measures from a plurality of calls to evaluate performance of the cellular communication system. The correlation of the termination call quality measure with the user call termination provides for data which more accurately reflects the user perceived call quality.

### FIELD OF THE INVENTION

The invention relates to a method and apparatus for determining call quality in a communication system and in particular but not exclusively, to determination of speech quality for system performance evaluation in a cellular communication system.

### BACKGROUND OF THE INVENTION

Over the past decades, cellular communication systems have become ubiquitous and today make up a major part of the communication service provision in many regions.

In a cellular communication system, a geographical region is divided into a number of cells each of which is served by a base station. The base stations are interconnected by a fixed network which can communicate data between the base stations. A mobile station is served via a radio communication link by the base station of the cell within which the mobile station is situated. Communication from a mobile station to a base station is known as uplink, and communication from a base station to a mobile station is known as downlink.

Currently, the most ubiquitous cellular communication system is the 2nd generation communication system known as the Global System for Mobile communication (GSM). Further description of the GSM TDMA communication system can be found in ‘The GSM System for Mobile Communications’ by Michel Mouly and Marie Bernadette Pautet, Bay Foreign Language Books, 1992, ISBN 2950719007.

In the past years, 3rd generation systems have been deployed to further enhance the communication services provided to mobile users. An example of such a communication system is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

One of the most important parameters of a cellular communication system is the call quality perceived by the users.

Also, even though 2^{nd} generation systems are continuously enhanced to provide further communication services and 3^{rd} generation systems have been designed to provide a variety of different communication services, the most important and most widely used communication service is still that of voice communication.

Consequently, one of the most important parameters of a cellular communication system is the speech quality perceived by users of voice services. Accordingly, methods and techniques for measuring and accessing such voice quality are of significant interest for operators and manufacturers of cellular communication systems.

However, the subjective perception of call quality, and in particular of speech quality, is difficult to determine accurately as this depends on many factors including a number of psychometric and subjective parameters. For example, a simple error rate measurement is often used as a rough indication of the voice quality. However, this only provides an inaccurate indication of the user perceived speech quality as this depends on many other parameters and characteristics.

Furthermore, at a system level, the performance as perceived by the users may not be accurately reflected by the continuous measurements. For example, the user's behaviour may affect the performance measures and may for example attenuate or accentuate specific patterns or characteristics which have an effect on the perceived call quality.

Typically, quality assessment for a cellular communication system is very complex. Typically large amounts of bandwidth and storage are required to process substantial amounts of data in order to achieve representative and reliable performance assessment.

Thus, an improved system for determining call quality would be advantageous and in particular a system for determining

call quality which allows increased flexibility, facilitated measurement operation, improved accuracy, improved correspondence to the user perceived call quality and/or improved system performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for determining call quality in a communication system, the apparatus comprising: means for determining a user call termination for a call; measuring means for determining a termination call quality measure for a call quality at the user call termination; and transmitting means for transmitting the termination call quality measure to a call quality processor.

The inventors of the current invention have realised that improved call quality determination may be achieved by determining a termination call quality measure associated with a user termination of a call. The invention may allow call quality determination that more accurately reflects a user perception of the call quality. For example, the user perception of voice quality may be biased towards poor quality events in the latter time intervals rather than in earlier time intervals. By determining call qualities for user call terminations this may be more accurately reflected and a call quality assessment that more accurately reflects the user perceived quality may be achieved.

Furthermore, by determining a termination call quality measure for a user termination, information may be provided for situations where calls are voluntarily terminated by a user due to poor quality. Such information is not obtained from dropped call statistics and may allow improved call quality information for the communication system to be determined.

The improved call quality may be used by the call quality processor to improve the quality of the communication system as a whole.

The invention may facilitate call quality assessment and may e.g. reduce bandwidth and storage requirements. In particular, a call quality measure being particularly representative of a user perception of call quality may be generated. This may allow fewer call quality measurements to be considered in determining a system call quality.

The call quality may be a speech quality or a parameter which is indicative of a speech quality. The call for which the call quality is assessed may be a voice call and may specifically be a voice conference call. The communication system may be a cellular communication system, such as a GSM or UMTS cellular communication system.

According to an optional feature of the invention, the measuring means is arranged to determine the call quality measure for a time interval immediately prior to the call termination.

This may allow an improved call quality measure to be determined and may in particular allow an improved correlation between the call quality measure and the user perception of the call quality.

The time interval may be a time interval which ends at the time of the call termination or ends within a short interval of less than ten seconds prior to the call termination.

According to an optional feature of the invention, the call quality measure is determined as a filtered value of a call quality characteristic in the time interval.

This may allow an improved call quality value more accurately reflecting the perceived voice quality. The filtered value may typically be a low pass filtered value of the call quality characteristic, such as a (possibly weighted) average value of the call quality characteristic.

According to an optional feature of the invention, the time interval has a duration of between 10 and 60 seconds.

This may allow an improved call quality value more accurately reflecting the perceived voice quality. In particular, the time interval may in many embodiments be selected to be between 30 and 40 seconds.

According to an optional feature of the invention, the measuring means comprises means for dynamically determining a call quality indication and for determining the call quality measure as the call quality indication in response to the detection of the user call termination.

This may provide for a low complexity and facilitated implementation while achieving high accuracy.

According to an optional feature of the invention, the call quality measure comprises an error rate for the call. In particular, the error rate may be an air interface Frame Erasure Rate (FER). This may provide for low complexity and facilitated implementation while achieving high accuracy and in particular may allow a call quality measure to be determined which provides a good indication of the call quality, such as the speech quality, as perceived by the user.

According to an optional feature of the invention, the measurement means comprises means for determining a second termination call characteristic measure for a call characteristic at the user call termination; and the transmitting means is further arranged to transmit the second call characteristic to the call quality processor. This may allow improved information of the call quality. In particular, it may allow an improved determination of the user perceived call quality by considering a plurality of parameters.

According to an optional feature of the invention, the second termination call characteristic comprises a discontinuous transmission activity indication.

This may allow an improved assessment of the call quality perceived by the user. In particular, the discontinuous transmission activity indication may together with other call quality characteristics, such as an air interface error rate, provide a particularly accurate indication of the user perceived call quality, such as a user perceived speech quality.

According to an optional feature of the invention, the second termination call characteristic comprises a handover activity indication.

This may allow an improved assessment of the call quality perceived by the user. In particular, the handover activity indication may together with other call quality characteristics, such as an air interface error rate, provide a particularly accurate indication of the user perceived call quality, such as a user perceived speech quality.

According to an optional feature of the invention, the means for determining the user call termination, the measuring means and the transmitting means are comprised in a remote terminal and the call quality processor is comprised in a fixed network of the communication system.

This may allow a practical implementation and an advantageous distribution of functionality. In particular, distributed termination call quality measures may be conveniently generated while allowing a centralised processing of the call quality measure. The approach may be particularly suited for downlink call quality assessment.

According to an optional feature of the invention, the means for determining the call termination, the measuring means and the transmitting means are comprised in a base station and the call quality processor is in the fixed network.

This may allow a practical implementation and an advantageous distribution of functionality. In particular, distributed termination call quality measures may be achieved while allowing a centralised processing of the call quality measure. The approach may be particularly suited for downlink call quality assessment.

According to an optional feature of the invention, the call quality measure is an uplink call quality measure. The invention may allow improved assessment of uplink call quality in a communication system.

According to an optional feature of the invention, the call quality measure is a downlink call quality measure. The invention may allow improved assessment of downlink call quality in a communication system.

According to a second aspect of the invention, there is provided a communication system comprising: a call quality processor; means for determining a user call termination for a call; measuring means for determining a termination call quality measure for a call quality at the user call termination; and transmitting means for transmitting the termination call quality measure to the call quality processor.

According to an optional feature of the invention, the call quality processor is arranged to receive termination call quality measures for a plurality of calls. This may allow improved and/or facilitated assessment of call qualities in the communication system. The call quality processor may be arranged to optimise or assist optimisation of the communication network thereby improving the performance of the communication system as a whole.

According to an optional feature of the invention, the call quality processor is arranged to perform statistical processing to determine a call quality indication for the plurality calls. This may allow improved and/or facilitated assessment of call qualities in the communication system. The call quality processor may be arranged to optimise or assist optimisation of the communication network thereby improving the performance of the communication system as a whole.

According to a third aspect of the invention, there is provided a method of determining call quality in a communication system, the method comprising: determining a user call termination for a call; determining a termination call quality measure for a call quality at the user call termination; and transmitting the termination call quality measure to a call quality processor.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system in accordance with some embodiments of the invention;

FIG. 2 illustrates an apparatus for determining call quality in a cellular communication system in accordance with some embodiments of the invention; and

FIG. 3 illustrates a method of determining a call quality in a cellular communication system in accordance with some embodiments of the invention.

### DETAILED DESCRIPTION OF SOME EMBODIMENTS OF THE INVENTION

The following description focuses on embodiments of the invention applicable to a GSM cellular communication system. However, it will be appreciated that the invention is not limited to this application but may be applied to many other communication systems including for example UMTS cellular communication systems.

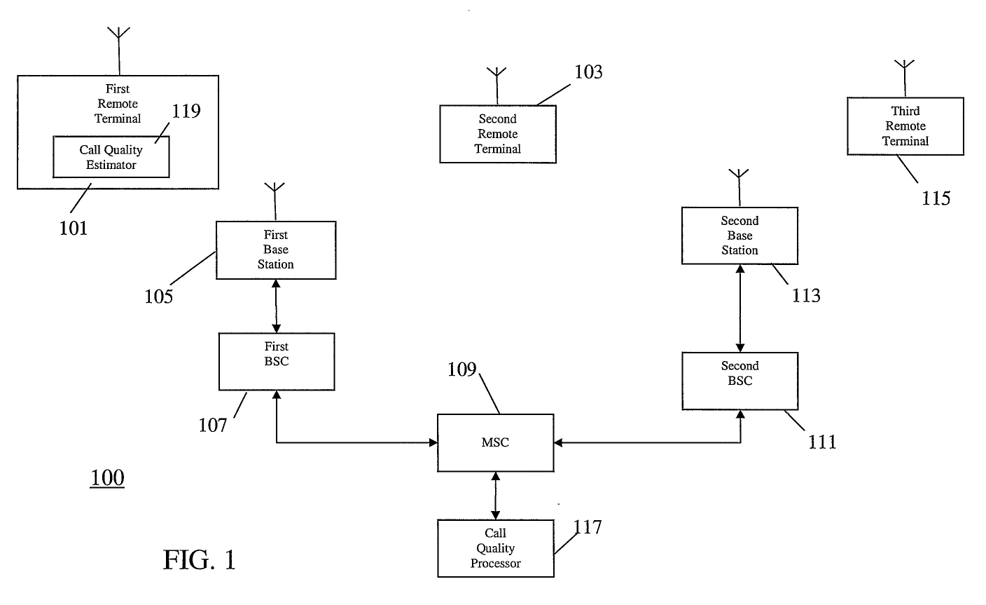

FIG. 1 illustrates an example of a cellular communication system 100 in accordance with some embodiments of the invention.

In the example of FIG. 1, a first remote terminal 101 and a second remote terminal 103 are in a first cell supported by a first base station 105.

A remote terminal may e.g. be a user equipment such as a 3rd Generation User Equipment (UE), a communication unit, a subscriber unit, a mobile station, a communication terminal, a personal digital assistant, a laptop computer, an embedded communication processor or any physical, functional or logical communication element which is capable of communicating over the air interface of the cellular communication system.

The first base station 105 is coupled to a first Base Station Controller (BSC) 107. A BSC performs many of the control functions related to the air interface including radio resource management and routing of data to and from appropriate base stations.

The first BSC 107 is coupled to a Master Switch Centre (MSC) 109. An MSC interconnects BSCs and is operable to route data between any two BSCs, thereby enabling a remote terminal in a cell to communicate with a remote terminal in any other cell. In addition, the MSC 109 may comprise gateway functions for interconnecting to external networks such as the Public Switched Telephone Network (PSTN), thereby allowing remote terminals to communicate with landline telephones and other communication terminals connected by a landline.

It will be appreciated that the cellular communication system comprises functionality for managing a conventional cellular communication network including functionality for routing data, admission control, resource allocation, subscriber billing, remote terminal authentication etc which will be well known to the person skilled in the art and need not be described further herein.

The MSC 109 is further coupled to a second BSC 111 which is coupled to a second base station 113. The second base station 113 supports a third remote terminal 115.

In the example, the cellular communication system 100 further comprises a call quality processor 117 which evaluates call quality performance in the system. In particular, the call quality processor 117 receives call quality measures relating to a large number of calls and performs statistical processing to evaluate system performance and in particular to identify unacceptable performance such as regions or cells not being provided with acceptable quality levels. The performance data generated by the call quality processor 117 may specifically be used for an optimisation of the cellular communication system for example by a reallocation of air interface resources between different cells.

In the example of FIG. 1, the call quality processor 117 is illustrated as coupled to the MSC 109 but it will be appreciated that in other embodiments it may be coupled to or be part of other elements of the cellular communication system. For example, the call quality processor 117 may be a separate and individual element coupled to an Operations and Management Center (OMC) or may for example be part of another network element such as a BSC, MSC or OMC.

In the system of FIG. 1, the call quality measures are provided to the call quality processor 117 by other network elements such as the remote terminals or the base stations. In the specific example, the first remote terminal 101 comprises a call quality estimator 119 which determines a termination call quality measure and transmits this to the call quality processor 117.

In the example of FIG. 1, the termination call quality measure is determined such that it reflects the call quality that a call has experienced immediately prior to a user termination. Thus, when the first remote terminal 101 detects that the user has terminated a call, a termination call quality measure indicative of the call quality at this time is generated and transmitted to the call quality processor 117. The user perception of call quality is heavily biased towards the conditions experienced immediately prior to call termination and the termination call quality measure reflects this subjectively perceived quality level.

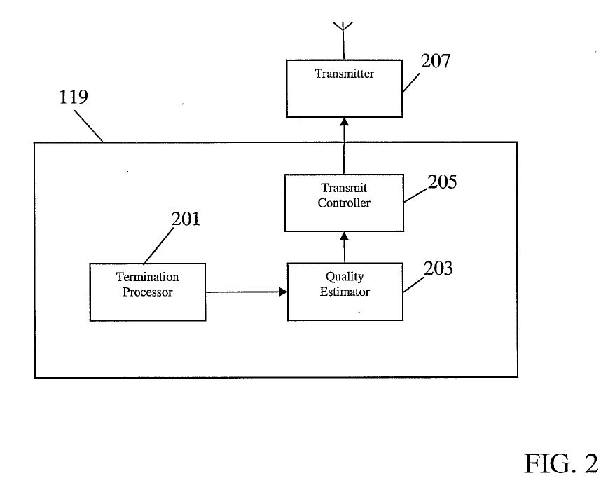

FIG. 2 illustrates the first remote terminal 101 and specifically the call quality estimator 119 in more detail.

The call quality estimator 119 comprises a termination processor 201 which is arranged to determine a user call termination for a call. In the specific example, the termination processor 201 may simply determine that the user has pressed an appropriate button on a keyboard of the first remote terminal 101 in order to terminate the call. As another example, the termination processor 201 may be coupled to a call controller (not shown) which controls the operation and management of the ongoing calls. When the call controller terminates a call, it may inform the termination processor 201 of this.

The termination processor 201 is coupled to a quality estimator 203 which is arranged to determine a termination call quality measure for a call quality at the user call termination. Thus, the termination call quality measure is indicative of the call quality when—or just prior—to the user terminating the call.

It will be appreciated that the quality estimator 203 may use any suitable means or algorithm for determining a termination call quality measure.

For example, in many embodiments, the air interface error rate is a good indicator of the perceived call quality. In particular, the quality estimator 203 may measure the Frame Erasure Rate (FER) of the air interface communications and determine the termination call quality measure as the FER experienced at the call termination. In the specific example, the quality estimator 203 determines a downlink call quality by evaluating a downlink characteristic of the call. Thus, the termination call quality measure may be determined as the FER of the downlink air interface connection at call termination. For example, when the termination processor 201 detects a user termination of a call, this may be indicated to the quality estimator 203. In response, the quality estimator 203 may determine an error rate in a time interval immediately prior to the user termination. For example, the quality estimator 203 may proceed to determine the average FER for a thirty second time interval ending at the time of the call termination. The average FER may for example be determined by averaging a number of FER values determined in the specific time interval or a new FER measurement may be generated by determining the number of frame erasures in the specific time interval.

It will be appreciated that the length and exact location of the time interval may be different in different embodiments and may be selected in response to the individual characteristics and requirements of the individual embodiments.

However, in many embodiments an interval length of between 10 and 60 seconds tends to provide a termination call quality measure which is sufficiently reliable and which reflects the subjective psychometric bias towards the conditions at call termination particularly well. In particular, a time interval between 30 and 40 seconds will provide a particularly suitable correspondence to the psychometric bias.

In many embodiments, a time interval finishing less than ten seconds before call termination will allow the termination call quality measure to accurately reflect the psychometric bias. Furthermore, in some embodiments it may be practical for the measurement interval to finish up to 10 seconds earlier than the call termination. For example, if a new FER measurement is generated every five seconds, the quality estimator 203 may generate a termination call quality measure comprising a FER obtained by averaging the last seven FER measurements.

A suitable interval may thus in many embodiments be an interval that starts between 10 and 60 seconds prior to call termination and finishes between 0 and 10 seconds prior to call termination.

The quality estimator 203 is coupled to a transmit controller 205 which is further coupled to a transmitter 207. The transmitter 207 is operable to transmit data over the air interface in accordance with the GSM Recommendations. The transmit controller 205 is arranged to transmit the termination call quality measure to the call quality processor 117. For example, the transmit controller 205 may be operable to initialise a General Packet Radio Service (GPRS) link to the call quality processor 117 and to transmit the termination call quality measure in a GPRS data packet.

In the example of FIG. 1, a large number of other remote terminals may also comprise functionality for determining termination call quality measures and for transmitting these to the call quality processor 117. Thus, the call quality processor 117 may receive large amounts of data and may statistically process this data to identify e.g. anomalies or regions with poor service.

As an example of the operation in the system of FIG. 1, a circuit switched voice call may exist between the first remote terminal 101 and the third remote terminal 115. If the user of the first and/or third remote terminal 101,115 terminates the call by an active user termination, the termination processor 201 may detect the termination. In response, a termination call quality measure will be determined and transmitted to the call quality processor 117.

A user may for example terminate a call because he has finished the call and accordingly a termination call quality measure indicative of the quality lastly perceived by the user is generated. However, users of a cellular communication system also regularly terminate calls because the call quality becomes unacceptable. For example, for a two way voice call, the system may be able to maintain the call although the speech quality may reach a level where communication becomes impossible or inconvenient. In this case, the users may terminate the call, and the remote terminals of FIG. 1 may generate a termination call quality measure and transmit this to the call quality processor 117.

Thus, the call quality processor 117 may receive a termination call quality measure which is indicative of a call quality that led the user to terminate the call. Such information is typically not obtained by conventional systems wherein normal user call terminations are ignored and only abnormal call terminations, such as dropped calls, are specifically evaluated. Hence, the approach may provide additional information and may in particular allow normal call terminations to be differentiated and evaluated.

Furthermore, as the termination call quality measure relates to the termination quality, a measure which much closer reflects the user perceived call quality is achieved. In particular, it has been found that the user perception of the voice quality of call is biased towards any poor quality events experienced in the last approximately thirty seconds of the users' experience (ref. e.g. “Experiments and Modelling of Perceived Speech Quality of Long Samples”, Xiang et al, Ericsson Research which describes the impact of human memory of the most recent events on perceived speech quality). This psychometric bias is inherently reflected in the described system as the call quality measure is determined to reflect the call quality at termination.

Furthermore, as the call quality assessment is specifically biased towards the psychometrically important call events, the requirements for continuously monitoring and evaluating the call quality may be reduced and the call quality processor 117 may generate accurate performance data based on much smaller data samples. Thus, the bandwidth and storage requirements for obtaining sufficient call quality data may be substantially reduced.

Although the above description has focussed on determination of a downlink call quality in a remote terminal, it will be appreciated that the described principles are equally applicable to uplink termination call quality measures and/or quality estimation in other network elements.

For example, in addition to the downlink termination call quality measure, the first base station 105 of FIG. 1 may be arranged to determine an uplink termination call quality measure.

The approach for the first base station 105 may be analogous to the approach described for the first remote terminal 101. Specifically, a call quality estimator, similar to the call quality estimator 119 described for the first remote terminal 101, may be implemented in the base station 203.

Thus, the first base station 105 may comprise a termination processor which detects when a call is terminated by a user. In particular, the termination processor may detect that a normal call termination rather than an abnormal termination (e.g. a dropped call) is performed. The termination processor may for example detect this from the standard GSM signalling messages exchanged by the first base station 105 and the first remote terminal 101.

A quality estimator may in response to a user termination determine a termination call quality measure. This may be determined in an analogous way to that described for the first remote terminal 101. For example, the quality estimator may determine an average FER for the uplink communication in a time interval beginning between 10 seconds and 60 seconds before and ending between 0 and 10 seconds before the detection of the call termination.

An transmit controller in the first base station 105 may then transmit the termination call quality measure to the call quality processor 117 using suitable communication channels on the interfaces of the fixed network. For example, the termination call quality measure determined by the first base station 105 may be transmitted to the call quality processor 117 as if it was a GPRS message received from the first remote terminal 101.

In some embodiments, the quality estimator(s) may first determine the quality estimate, such as the FER, when the call termination is detected. However, alternatively or additionally, the quality estimator(s) may also continuously determine a call quality indication and the termination call quality measure may be determined as the value of the call quality indication when the call termination is detected.

For example, the first remote terminal 101 may continuously determine a FER rate. The FER data may continuously be low pass filtered by the quality estimator 203 to derive a low pass filtered call quality indication that has the desired dynamic characteristics. For example, the quality estimator 203 may continuously determine a running average for the previous 30 seconds. When the termination processor 201 indicates that a user has terminated the call, the quality estimator 203 may simply determine the termination call quality measure as the current value of the low pass filtered FER.

It will be appreciated that although the above description has focussed on an embodiment wherein the termination call quality measure comprises a single call quality characteristic, specifically the FER, two or more call characteristics may be included in the termination call quality measure and transmitted to the call quality processor 117 in other embodiments.

By including more call quality characteristics in the termination call quality measure, the call quality processor 117 may perform an improved call quality assessment which more accurately reflects the subjectively perceived call quality by users.

Specifically, for a speech signal the termination call quality measure may comprise a discontinuous transmission activity indication and/or a handover activity indication indicative of the operation immediately prior to the call termination.

For example, when a user call termination is detected, the first remote terminal 101 may transmit a termination call quality measure comprising the average FER, the number of handovers and the proportion of time in discontinuous transmission mode (known as DTX for a GSM cellular communication system) for a 30 second time interval immediately prior to the detection of the user call termination.

The combination of an error rate indication together with a handover and/or discontinuous transmission activity indication provides particularly suitable parameters for determining a subjective speech quality indicative of the psychometric perception of call quality by users.

It will be appreciated that in some embodiments, the termination call quality measure may comprise a combined parameter determined in response to a plurality of call quality indicators. For example, the termination call quality measure may directly comprise a speech quality indication determined by the quality estimator 203 in response to the determined FER, handover and discontinuous transmission activity.

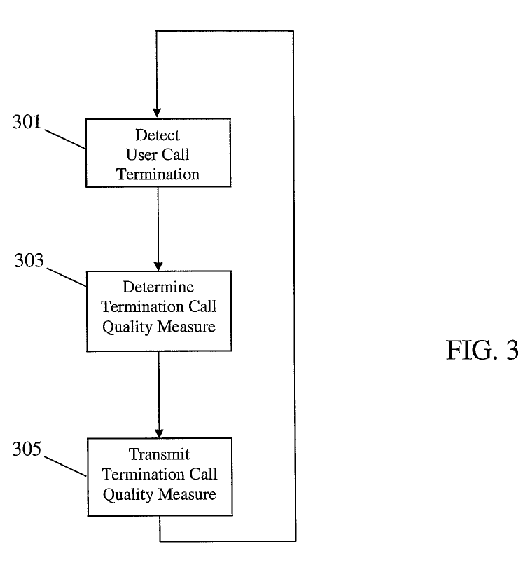

FIG. 3 illustrates a method of determining a call quality in a cellular communication system in accordance with some embodiments of the invention. The method is applicable to the call quality estimator 119 of FIG. 1 and will be described with reference to this.

The method initiates in step 301 wherein the termination processor 201 determines a user call termination for a call.

Step 301 is followed by step 303 wherein the quality estimator 203 determines a termination call quality measure for a call quality at the user call termination.

Step 303 is followed by step 305 wherein the transmit controller 205 transmits the termination call quality measure to a call quality processor 217.

It will be appreciated that although the above description has focussed on embodiments in a cellular communication system the principles are equally applicable to other communication systems including for example fixed line voice communication systems. For example, the principles may be applied to calls such as fixed-fixed calls, mobile-mobile calls, mobile-fixed calls, mobile-VoIP (Voice over Internet Protocol) calls, VoIP-VoIP calls, or an ad-mix on a conference call.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. An apparatus for determining call quality in a communication system, the apparatus comprising:
means for determining a user call termination for a call;
measuring means for determining a measured call quality measure for a call quality immediately prior to termination of the call; and
transmitting means for transmitting the termination call quality measure to a call quality processor.

2. The apparatus claimed in claim 1 wherein the call quality measure is determined as a filtered value of a call quality characteristic in the time interval.

3. The apparatus claimed in claim 1 wherein the measuring means comprises means for dynamically determining a call quality indication and for determining the call quality measure as the call quality indication in response to the detection of the user call termination.

4. The apparatus claimed in claim 1 wherein the call quality measure comprises an error rate for the call.

5. The apparatus claimed in claim 1 wherein the measurement means comprises means for determining a second termination call characteristic measure for a call characteristic at the user call termination; and wherein the transmitting means is further arranged to transmit the second call characteristic to the call quality processor.

6. The apparatus claimed in claim 5 wherein the second termination call characteristic comprises a discontinuous transmission activity indication.

7. The apparatus claimed in claim 5 wherein the second termination call characteristic comprises a handover activity indication.

8. The apparatus claimed in claim 1 wherein the means for determining the user call termination, the measuring means and the transmitting means are comprised in a remote terminal and the call quality processor is comprised in a fixed network of the communication system.

9. The apparatus claimed in claim 1 wherein the means for determining the call termination, the measuring means and the transmitting means are comprised in a base station and the call quality processor is in the fixed network.

10. A method of determining call quality in a communication system, the method comprising:
determining a user call termination for a call;
determining a measured call quality measure for a call quality immediately prior to termination of the call; and
transmitting the termination call quality measure to a call quality processor.
